(19) United States
(12) Patent Application Publication
(10) Pub. No.: US 2025/0165199 A1
(43) Pub. Date: May 22, 2025

(54) CLOUD PRINT SYSTEM AND CONTROL METHOD THEREOF

(71) Applicant: CANON KABUSHIKI KAISHA, Tokyo (JP)

(72) Inventor: HIDEKI HANANO, Kanagawa (JP)

(21) Appl. No.: 18/936,185

(22) Filed: Nov. 4, 2024

(30) Foreign Application Priority Data
Nov. 16, 2023 (JP) 2023-195298

(51) Int. Cl. G06F 3/12

(52) U.S. Cl. CPC G06F 3/126; G06F 3/1205; G06F 3/1288

(57) ABSTRACT

The cloud print system executes printing of, by the printer based on an instruction from the mobile device, a print job stored in the cloud server. The cloud server receives a print job submitted by a user; stores the print job in a memory device; transmits, by push notification, information regarding the print job to a mobile device of a notification destination associated with a user who submits the received print job; and transmits the print job stored in the memory device to the printer based on an instruction for execution of the print job. The mobile device receives the push notification from the cloud server; displays a message on a display when receiving the push notification; and transmits an instruction for execution of the print job to the cloud server based on a user's operation on the message.

### BACKGROUND OF THE INVENTION

### Field of the Invention

The present invention relates to a cloud print system and a control method thereof.

### Description of the Related Art

Known print services realize printing by a user directly transmitting a print job directly to a printer from a client device such as a PC. On the other hand, in recent years, a cloud print service using a cloud service provided on the Internet has been proposed.

Here, a processing sequence of a known cloud print will be described with reference to FIG. 1. It is assumed that a printer 101 supports a cloud print function and a WebUI function for operating the printer 101. It is assumed that a client device 100 supports a cloud print client function and a WebUI client for operating the WebUI. In addition, a cloud print service 102 represents a cloud print service on the Internet.

First, using the WebUI client of the client device 100, the user transmits a cloud print service registration request 111 to the printer 101 via the WebUI. Upon receiving the request 111, the printer 101 transmits a cloud print service registration request 112 to the cloud print service 102. Upon receiving the request 112, the cloud print service 102 transmits, to the printer 101, a cloud print service registration request response 113 including a registration URL 130 for cloud print registration. Upon receiving the response 113, the printer 101 transmits registration URL display screen information 114 including a cloud print service registration URL to the client device 100 via the WebUI.

Upon receiving the screen information 114, the client device 100 displays a registration URL on the WebUI client. The user operates the WebUI client of the client device 100 to access the displayed registration URL. Due to this, the client device 100 transmits a cloud print service registration approval request 115 including a cloud account 131 to the cloud print service 102. Upon receiving the registration approval request 115, the cloud print service 102 transmits a cloud print service registration approval response 116 to the client device 100. The cloud account 131 indicates a user having authority to use the cloud print service 102, and the user has registered a user account in the cloud print service 102 in advance.

The printer 101 transmits a cloud print service registration confirmation request 117 to the cloud print service 102. Upon receiving the request 117, the cloud print service 102 transmits a cloud print service registration confirmation response 118 including a cloud printer ID 132 to the printer 101. At this stage, the printer 101 is in a state of being registered in the cloud print service 102 and is ready to use the cloud print service.

When the registration is completed up to the sequence, the printer 101 then transmits a cloud print service printer information update request 119 to the cloud print service 102. The request 119 includes a printer attribute 135 of the printer 101. Upon receiving the request 119, the cloud print service 102 transmits a cloud print service printer information update response 120 to the printer 101.

Next, the printer 101 transmits an event request 121 to the cloud print service 102. The event request 121 designates a job reception event as a type of event to be requested.

The client device 100 transmits a cloud printer information request 122 to the cloud print service 102. The cloud printer information request 122 includes the cloud account 131. Upon receiving the cloud printer information request 122, the cloud print service 102 acquires printer information that the cloud account 131 included therein can use. Then, the cloud print service 102 transmits, to the client device 100, a cloud printer information response 123 including the cloud printer ID 132 indicating the printer information and the printer attribute 135. Here, the printer attribute 135 is one that the printer 101 has transmitted to the cloud print service 102 by the cloud print service printer information update request 119.

The client device 100 transmits, to the cloud print service 102, a print request 124 including the cloud printer ID 132, print data 134, and the cloud account 131. Upon receiving the print request 124, the cloud print service 102 transmits an event response 125 to the printer 101. The event response 125 is transmitted as a response to the event request 121, and a job reception event is designated as a type of event.

Upon receiving the event response 125, the printer 101 transmits a print job request 126 to the cloud print service 102. The cloud print service 102 transmits a print job response 127 including the print data 134 and the cloud account 131 to the printer 101. The printer 101 prints the received print data. Japanese Patent Laid-Open No. 2021-170258 discloses a cloud print service.

Japanese Patent Laid-Open No. 2020-009062 discloses printing executed by once storing a print job transmitted from a user in a print server without specifying a printer, and instructing printing again by the user in a state where the printer that executes printing is specified.

However, assuming that in addition to the hold printing disclosed in Japanese Patent Laid-Open No. 2020-009062, the cloud print disclosed in Japanese Patent Laid-Open No. 2020-009062 also corresponds to the hold printing, the printer corresponds to two types of hold printing. As a result, there are problems of a large number of steps of the user operating the printer and a large number of steps of the user in the case of executing hold printing from a smartphone, and low usability.

### SUMMARY OF THE INVENTION

The present invention enables realization of improvement of user's operability when executing hold printing from a smartphone in a case where a cloud print service supports hold printing.

One aspect of the present invention provides a cloud print system including a printer, a cloud server, and a mobile device, executes printing of, by the printer based on an instruction from the mobile device, a print job submitted to and stored in the cloud server, wherein the cloud server comprises: one or more first memory devices that store a set of instructions; and one or more first processors that execute the set of instructions to: receive a print job submitted by a user; store the print job in the one or more first memory device; transmit, by push notification, information regarding the print job to a mobile device of a notification destination associated with a user who submits the received print job; and transmit the print job stored in the one or more first memory device to the printer based on an instruction for execution of the print job, and the mobile device comprises: a display; one or more second memory devices that store a set of instructions; and one or more second processors that execute the set of instructions to: receive the push notification from the cloud server; display a message on the display when receiving the push notification; and transmit an instruction for execution of the print job to the cloud server based on a user's operation on the message.

Another aspect of the present invention provides a method for controlling a cloud print system including a printer, a cloud server, and a mobile device, wherein the cloud print system executes printing of, by the printer based on an instruction from the mobile device, a print job submitted to and stored in the cloud server, the method wherein the cloud server receives a print job submitted by a user, stores the print job, and transmits, by push notification, information regarding the print job to a mobile device of a notification destination associated with a user who submits the received print job, the mobile device receives the push notification from the cloud server, displays a message on a display upon receiving the push notification, and transmits an instruction for execution of the print job to the cloud server based on a user's operation on the message, and the cloud server transmits the print job stored in a storage unit to the printer based on an instruction for execution of the print job.

Further features of the present invention will be apparent from the following description of exemplary embodiments with reference to the attached drawings.

### BRIEF DESCRIPTION OF THE DRAWINGS

FIG. 1 is a processing sequence diagram of cloud print.

FIG. 2 is a network diagram illustrating a configuration of pull printing in cloud print.

FIG. 3 is a network diagram illustrating a configuration of secure print.

FIG. 4 is a hardware configuration diagram of a printer in one embodiment.

FIG. 5 is a software configuration diagram of the printer in one embodiment.

FIG. 6 is an explanatory diagram of an operation panel of the printer in one embodiment.

FIG. 7 is a hardware configuration diagram of a cloud print service in one embodiment.

FIG. 8 is a software configuration diagram of the cloud print service in one embodiment.

FIG. 9 is a sequence diagram when the printer in one embodiment executes pull printing in cloud print.

FIG. 10 is a view illustrating attribute information designating a job release method supported by the printer in one embodiment.

FIG. 11 is a view illustrating a screen for performing secure print setting in the printer in one embodiment.

FIG. 12 is a flowchart when the printer in one embodiment receives a cloud print job reception event.

FIG. 13 is a flowchart when the cloud print service in one embodiment receives a print request for a job.

FIG. 14 is a processing flow diagram of instructing print execution by push notification, to a mobile device, of a print job of pull printing in one embodiment.

FIGS. 15A and 15B are push notification setting screens in one embodiment.

FIG. 16 is a registration processing sequence of a push notification destination device in one embodiment.

FIGS. 17A to 17C are push notification screens of a mobile device in one embodiment.

FIG. 18 is a sequence diagram when the mobile device in one embodiment receives push notification and executes a print job of pull printing.

FIGS. 19A and 19B are print job list screens in one embodiment.

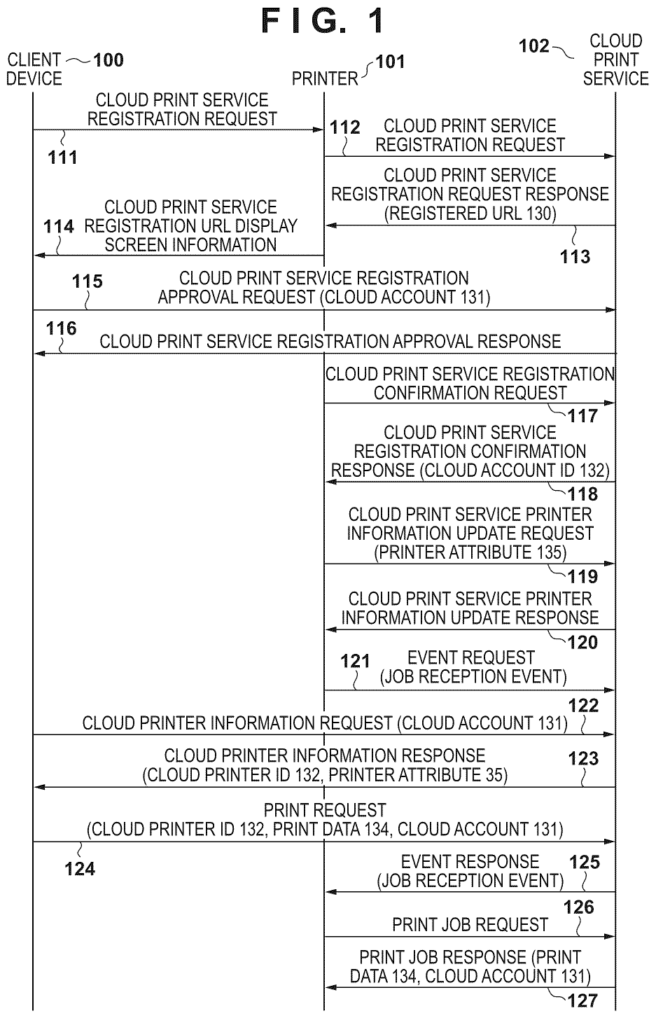

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

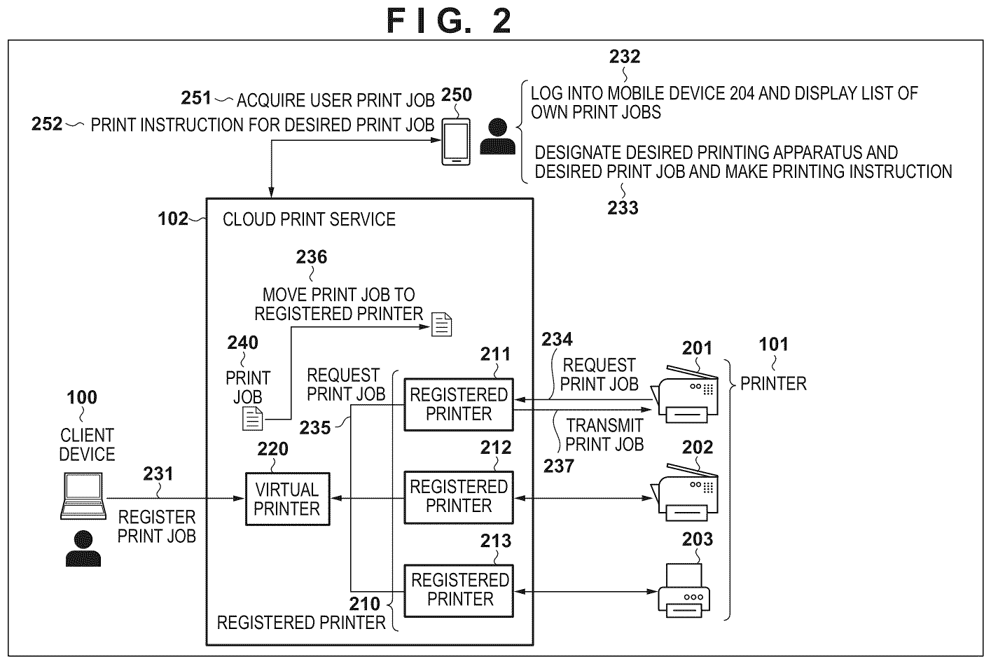

Two types of hold printing assumed in the present embodiment will be described. Hold printing includes two types of hold printing, pull printing in cloud print and secure print. First, pull printing in cloud print will be described with reference to FIG. 2.

In the cloud print service 102, there is a registered printer 210 corresponding to the printer 101 on a one-to-one basis. The state of the corresponding printer 101 and the job state during printing are reflected in the registered printer 210. In the present embodiment, a printer 201 corresponds to a registered printer 211, a printer 202 corresponds to a registered printer 212, and a printer 203 corresponds to a registered printer 213. A mobile device 204 can display a list of print jobs of users who are logged in. This is realized by the mobile device 204 acquiring (251) a print job of a user who is logged in from the cloud print service 102.

In the mobile device 204, the user can issue a print instruction (233) to the cloud print service 102 by designating the printer 101 and a print job. This is realized by the mobile device 204 transmitting (252) a print job and information of the printer 101 to the cloud print service 102.

In the cloud print service 102, there is a virtual printer 220. A plurality of the registered printers 210 can be associated with the virtual printer 220. In the present embodiment, the registered printer 211, the registered printer 212, and the registered printer 213 are associated with the virtual printer 220.

Hereinafter, a processing flow of pull printing using the virtual printer 220 will be described. First, the user registers (231) a print job into the virtual printer 220 from the client device 100. The user logs in to the mobile device 204 and displays (232) his/her own print job list. Then, the user designates (233) a desired job and instructs print execution. The printer 201 requests (234) the corresponding registered printer 211 for the print job designated in 233. The registered printer 211 requests (235) the virtual printer 220 for the print job. The virtual printer 220 moves (236) the print job to the registered printer 211. The registered printer 211 transmits (237) the print job to the printer 201 as a response to a print job request 234. The printer 201 prints the received print job.

This enables the user to print, with a discretionary printer 101 associated with the virtual printer 220, the print job submitted to the virtual printer 220.

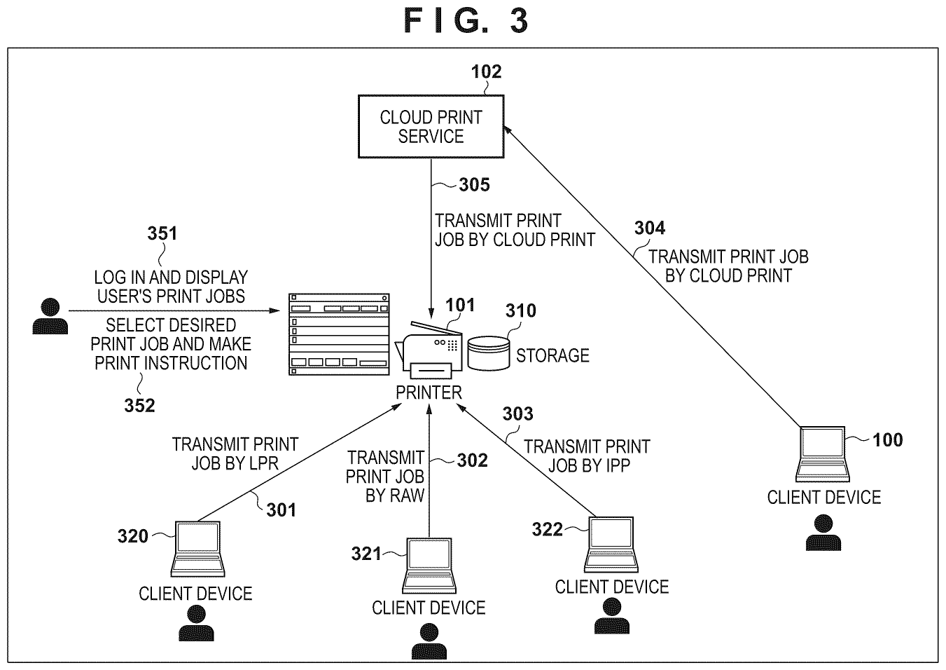

Next, with reference to FIG. 3, secure print, which is the other type of hold printing, will be described. In the secure print, upon receiving a print job from a client device, the printer 101 does not perform printing and stores the print job into a storage 310 such as an HDD in the printer 101. When performing printing, first, the user logs in (351) to the printer 101 from the operation panel of the printer 101. Then, printing is executed (352) by designating a desired print job and instructing printing with reference to an own print job list.

The printer 101 may receive the print job from the client device in any manner. FIG. 3 illustrates a case where a client device 320 transmits (301) a print job to the printer 101 by LPR, a case where a client device 321 transmits (302) a print job to the printer 101 by RAW, a case where a client device 322 transmits (303) a print job to the printer 101 by IPP, and a case where the client device 100 transmits (304) a print job by cloud print and transmits (305) the print job to the printer 101 by cloud print via the cloud print service 102. The print instruction of the secure print is issued twice, at a timing (301 to 304) at which the user issues a print instruction on print target data and at a timing (352) at which the user issues a print instruction on a stored print job.

Here, if both the pull printing in the cloud print described with reference to FIG. 2 and the secure print described with reference to FIG. 3 are valid, the user needs to log in twice in order to execute printing, which is poor in operability. Specifically, in order to execute pull printing in the cloud print, the user logs in to the cloud print service 102 from the mobile device 204 and displays (232) his/her own print job list. Then, the user designates the desired job and the printer 101, and instructs (233) print execution. Then, the print job is stored in the storage 310 of the printer 101. The user logs in to the printer 101 from the operation panel of the printer 101, with reference to his/her own print job list, designates the desired print job, and executes printing.

Hereinafter, a specific method of eliminating the login processing performed twice when both the pull printing in the cloud print described with reference to FIG. 2 and the secure print described with reference to FIG. 3 are valid will be described.

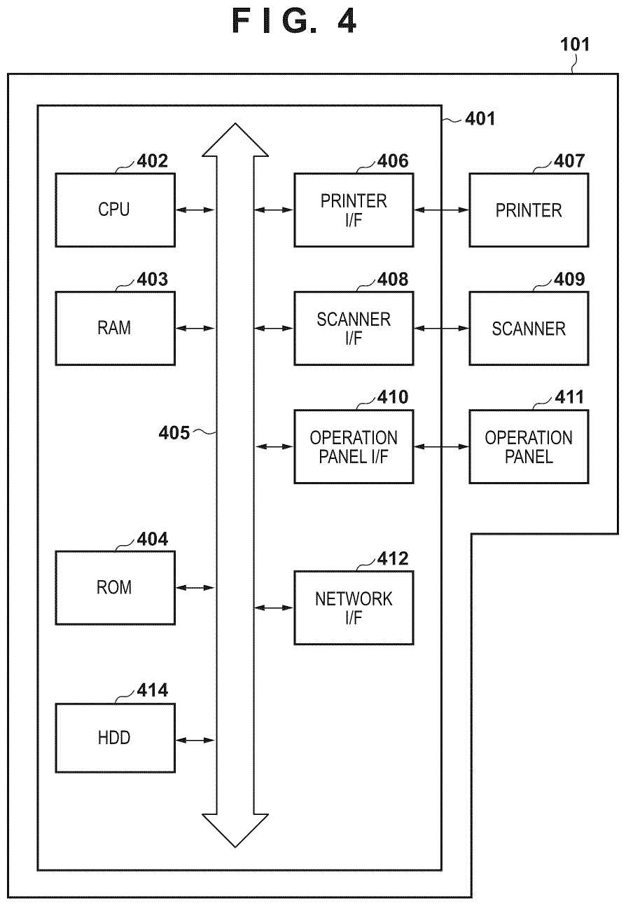

First, the hardware configuration of the printer 101 according to the present embodiment will be described with reference to FIG. 4. The printer 101 includes a control unit 401, a printer 407, a scanner 409, and an operation panel 411. The control unit 401 includes a CPU 402, a RAM 403, a ROM 404, a system bus 405, a printer I/F 406, a scanner I/F 408, an operation panel I/F 410, and a network I/F 412.

The control unit 401 including the CPU 402 controls the entire operation of the printer 101. The CPU 402 reads a control program stored in the ROM 404 and performs various types of control such as communication control. The RAM 403 is used as a temporary storage area such as a main memory and a work area of the CPU 402. An HDD 414 stores data, various programs, or various information tables.

The printer I/F 406 serves as an interface for outputting an image signal to the printer 407 (printer engine). The scanner I/F 408 serves as an interface for inputting a read image signal from the scanner 409 (scanner engine). The CPU 402 processes the image signal input from the scanner I/F 408, and outputs the image signal to the printer I/F 406 as a record image signal.

The operation panel I/F 410 connects the operation panel 411 and the control unit 401. The operation panel 411 includes a liquid crystal display having a touch panel function and a keyboard.

The network I/F 412 transmits information to an external device such as the client device 100 and the cloud print service 102, or receives various types of information from those external devices.

Blocks in the control unit 401 are connected by the system bus 405.

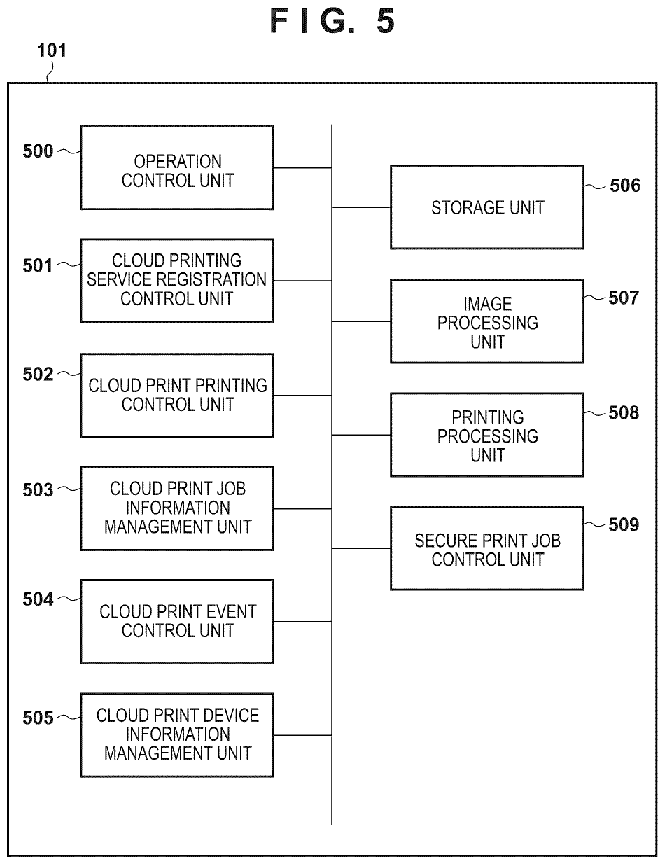

The software configuration of the printer 101 according to the present embodiment will be described with reference to FIG. 5.

The software of the printer includes an operation control unit 500, a cloud print service registration control unit 501, a cloud print printing control unit 502, a cloud print job information management unit 503, a cloud print event control unit 504, a cloud print device information management unit 505, a storage unit 506, an image processing unit 507, and a print processing unit 508. Each functional unit illustrated in FIG. 5 is realized by the CPU 402 included in the printer 101 reading, and executing, a control program stored in the ROM 404 or the HDD 414 into the RAM 403.

The operation control unit 500 controls the operation panel 411. The operation control unit 500 displays an operation menu on the operation panel 411 to wait for an instruction input from the user, notifies another functional unit of received instruction content, and displays an instruction result on the operation panel 411.

The cloud print service registration control unit 501 analyzes the cloud print service registration request 111 received from client device 100, and transmits the cloud print service registration request 112 to the cloud print service 102. This controls cloud print service registration processing.

The cloud print printing control unit 502 transfers, to the image processing unit 507, the print data 134 received from the cloud print service 102. The image processing unit 507 performs processing of rendering a print job into image data for printing.

The print processing unit 508 performs processing of printing the image data rendered by the image processing unit 507.

The cloud print job information management unit 503 manages, and notifies the cloud print service 102 of, job information of the printer 101.

The cloud print event control unit 504 controls event transmission and event reception processing between the printer 101 and the cloud print service 102.

The cloud print device information management unit 505 manages, and notifies the cloud print service 102 of, device information of the printer 101.

By an instruction from another functional unit, the storage unit 506 stores designated data into the ROM 404 or the HDD 414 or reads stored data. Examples of data managed by the storage unit 506 include print job information.

A secure print job control unit 509 controls a secure print job.

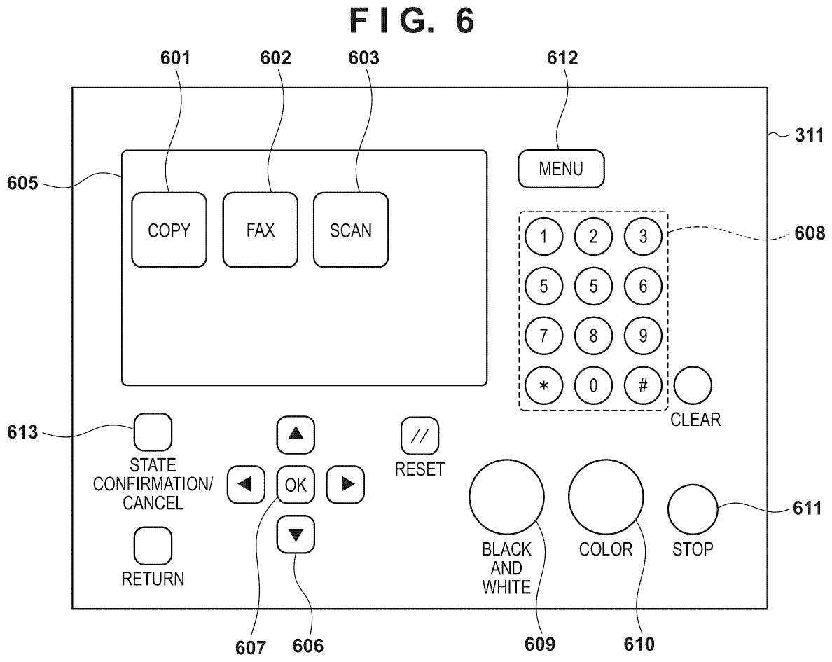

The operation panel 411 of the printer 101 according to the present embodiment will be described with reference to FIG. 6. The operation panel 411 includes, arranged therein, a display panel 605, a direction key 606, an OK key 607, a numeric keypad 608, a black-and-white button 609, a color button 610, a stop button 611, a menu button 612, and a status confirmation/cancel button 613. The display panel 605 is a display panel using an LCD or the like. A copy button 601 is a button operated when copying is performed using the printer 101, and a copy operation screen is displayed on the display panel 605 by operating the copy button 601. A FAX button 602 is a button operated when FAX is performed using the printer 101, and a FAX operation screen is displayed on the display panel 605 by operating the FAX button 602. A scan button 603 is a button operated when scanning is performed using the printer 101, and a scan operation screen is displayed on the display panel 605 by operating the scan button 603. A dialog for exchange with the user is also displayed on the display panel 605. Furthermore, in the present embodiment, a login screen of the user and a print job list display screen are displayed.

The numeric keypad 608 is used for inputting numbers and the like. The OK key 607 is used when deciding display content of the display panel 605. The direction key 606 is used when selecting a menu or the like displayed on the display panel 605. The black-and-white button 609 and the color button 610 are used when executing black-and-white copy and color copy, respectively. The stop button 611 is used when stopping processing. The menu button 612 is used when displaying a menu screen for setting the printer 101. The status confirmation/cancel button 613 is used when confirming the status of the printer 101, such as a list of print jobs being received by the printer 101.

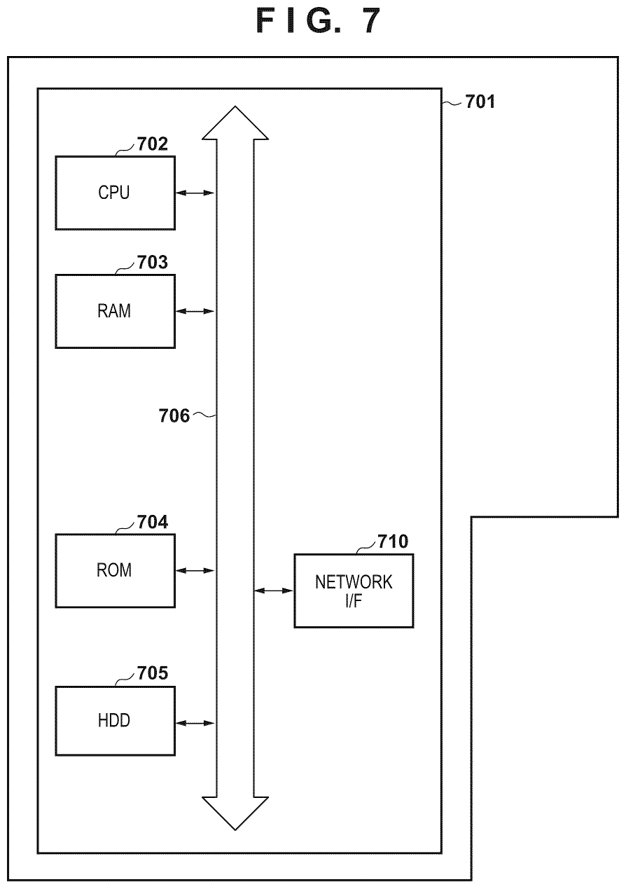

With reference to FIG. 7, the hardware configuration of a cloud server on which the cloud print service 102 according to the present embodiment is executed will be described. The cloud server includes a control unit 701, and the control unit 701 includes a CPU 702, a RAM 703, a ROM 704, an HDD 705, a system bus 706, and a network I/F 710. Blocks in the control unit 701 are connected by the system bus 706.

The control unit 701 including the CPU 702 controls the entire operation of the cloud print service 102. The CPU 702 performs various types of control such as communication control by reading a control program stored in the ROM 704 into the RAM 703 and executing the same. The RAM 703 is used as a temporary storage area such as a main memory and a work area of the CPU 702. The HDD 705 stores data, various programs, or various information tables. The HDD 705 holds and stores the print job submitted from the client device. The network I/F 710 transmits information to an external device such as the client device 100 and the printer 101, or receives various types of information from those external devices.

Blocks in the control unit 701 are connected by the system bus 706.

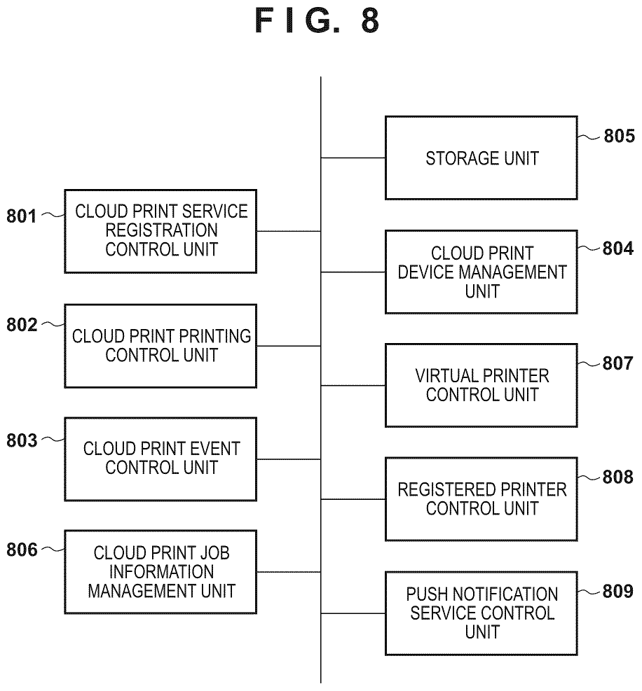

With reference to FIG. 8, the software configuration of a cloud server on which the cloud print service 102 according to the present embodiment is executed will be described. The software of the cloud server includes a cloud print service registration control unit 801, a cloud print printing control unit 802, a cloud print event control unit 803, a cloud print device management unit 804, a storage unit 805, a cloud print job information management unit 806, a virtual printer control unit 807, a registered printer control unit 808, and a push notification service control unit 809. Each functional unit illustrated in FIG. 8 is realized by the CPU 702 included in the cloud server reading, and executing, a control program stored in the ROM 704 into the RAM 703.

The cloud print service registration control unit 801 receives the cloud print service registration request 112 from the printer 101 and executes processing of registering the printer 101 in the cloud print service 102. The cloud print printing control unit 802 receives the print request 124 from the client device 100, and executes processing of transmitting the print data 134 included in the print request 124 to the printer 101. In response to the event request 121 from the printer 101, the cloud print event control unit 803 executes processing of transmitting the event response 125 in accordance with presence or absence of an occurrence of an event.

The cloud print job information management unit 806 manages information and a state of a print job.

The cloud print device management unit 804 manages a plurality of the printers 101 registered in the cloud print service 102. Specifically, capability information of a printer corresponding to each printer 101 and information of a print queue in which the print job is spooled are stored and managed.

By an instruction from another functional unit, the storage unit 805 stores designated data into the ROM 404 or the HDD 414 or reads stored data. Examples of the data managed by the storage unit 805 include print data, event information, and capability information of the registered printer 101. The storage unit 805 functions as a storage unit that holds and stores, in the HDD 414, the print job submitted from the client device.

The virtual printer control unit 807 manages information of the virtual printer 220 registered in the cloud print service 102. Here, the virtual printer 220 is a conceptual printer object existing on the cloud print service 102. The virtual printer 220 does not directly correspond to the printer 101, which is a real printer. The information of the virtual printer 220 includes capability information of the virtual printer 220, a print queue, and information of the associated registered printer 210.

The registered printer control unit 808 manages information on the registered printer 210 registered in the cloud print service 102. Here, the registered printer 210 is a conceptual printer object existing on the cloud print service 102. The registered printer 210 is generated when the printer 101 is registered in the cloud print service 102, and has a one-to-one correspondence with the registered printer 101. The information of the registered printer 210 includes capability information of the registered printer 210 and information of a print queue.

In cooperation with a push notification server provided by a company that develops an operating system (OS) of the mobile device 204, the push notification service control unit 809 activates an application program of the mobile device 204 by push notification to display a message. For example, examples of the push notification server as a service compatible with iOS provided by Apple Inc. include Apple Push Notification service (APNs). In a case where the OS of the mobile device 204 is iOS (registered trademark), a server for APNs is used as a push notification server. Examples of the push notification server as a service compatible with Android (registered trademark) provided by Google Inc. include Firebase Cloud Messaging (FCM). In a case where the OS of the mobile device 204 is Android, a server for FCM is used as a push notification server.

The following description assumes that the printer 101 and the cloud print service 102 perform communication using Internet Printing Protocol (IPP).

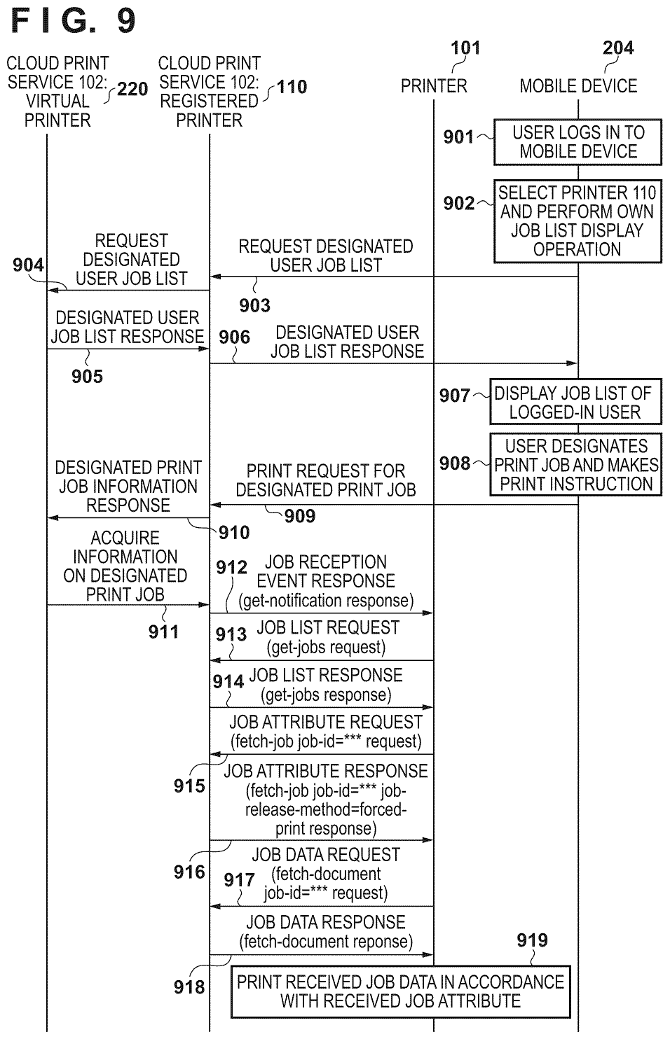

The sequence when the printer 101 in the first embodiment executes pull printing in cloud print will be described with reference to FIG. 9.

The user logs in (901) to the cloud print service 102 on the mobile device 204. The user selects a desired printer 101 and performs an operation for displaying his/her job list (902). The mobile device 204 requests (903) a registered printer 110 on the cloud print service 102 for a job list of the user who has logged in 901.

The registered printer 110 on the cloud print service 102 requests (904) the virtual printer 220 for a job list of the user designated in 903. The virtual printer 220 on the cloud print service 102 responds (905) to the registered printer 110 for the job list of the user designated in 904. The registered printer 110 on the cloud print service 102 responds (906) to the mobile device 204 for the job list of the user designated in 903.

The mobile device 204 displays the received job list (907). The user selects a desired job from the displayed job list and performs an operation for printing (908). The mobile device 204 transmits (909) a print request for the designated print job to the registered printer 110 on the cloud print service 102. The registered printer 110 on the cloud print service 102 requests (910) the virtual printer 220 for information on the print job specified in 909. The virtual printer 220 on the cloud print service 102 responds (911) to the registered printer 110 for the information on the print job designated in 910. The registered printer 110 on the cloud print service 102 responds (912) to the printer 101 for a job reception event. Specifically, the registered printer 110 transmits a response of get-notification, which is an event acquisition request of IPP. Here, as a type of event, job-fetchable indicating presence of a received job is set.

The printer 101 transmits (913) a job list request to the registered printer 110 on the cloud print service 102. Specifically, the printer 101 transmits a request of get-jobs, which is a job list acquisition request of IPP. The registered printer 110 on the cloud print service 102 transmits (914) a job list response to the printer 101. Specifically, the registered printer 110 transmits a response of get-jobs, which is an event acquisition request of IPP. The printer 101 transmits (915) a job attribute request to the registered printer 110 on the cloud print service 102. Specifically, the printer 101 transmits a request of fetch-job, which is a job attribute acquisition request of IPP. At this time, job-id acquired in 914 is designated as job-id.

The registered printer 110 on the cloud print service 102 transmits (916) a job attribute response to the printer 101. Specifically, the registered printer 110 transmits a response of fetch-job, which is a job attribute acquisition request of IPP. At this time, job-release-method instructing a job release method is set as the job attribute.

The printer 101 transmits (917) a job data request to the registered printer 110 on the cloud print service 102. Specifically, the printer 101 transmits a request of fetch-document, which is a job data acquisition request of IPP. At this time, job-id acquired in 914 is designated as job-id. The registered printer 110 on the cloud print service 102 transmits (918) a job data response to the printer 101. Specifically, the registered printer 110 transmits a response of fetch-document, which is a job data acquisition request of IPP. The printer 101 outputs the received job data in accordance with the received job attribute.

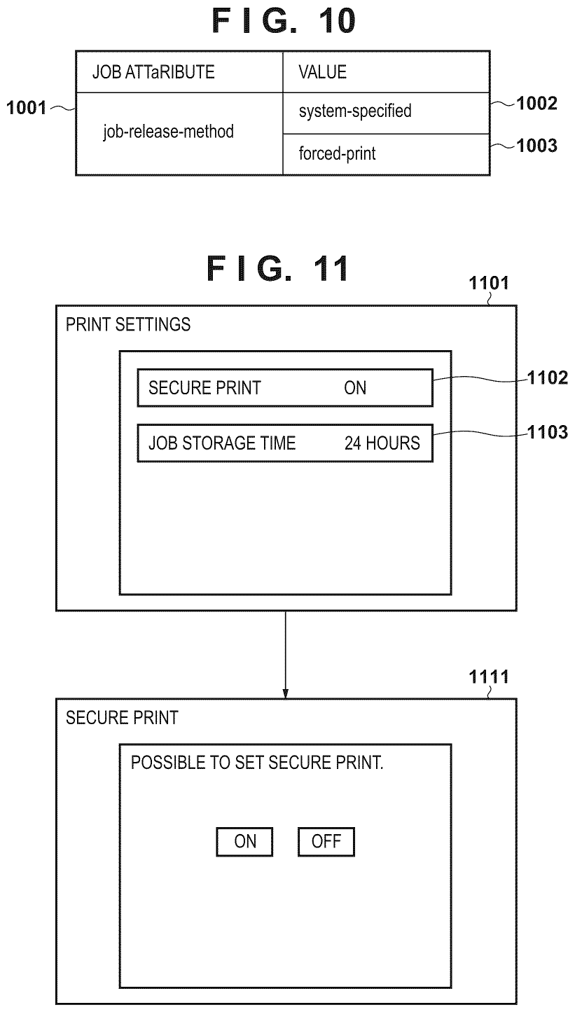

Attribute information for designating a job release method supported by the printer in the present embodiment will be described with reference to FIG. 10.

The job attribute of FIG. 10 is job-release-method (1001) notified as a print attribute from the cloud print service 102 to the printer 101 in 916 of FIG. 9. It is the cloud print service 102 that can designate the present job attribute. Hence, it is assumed that a print job transmitted by an external device different from the cloud print service 102 does not include the present job attribute.

Values supported by job-release-method include system-specified (1002) (system specific) and forced-print (1003) (forced printing).

In a case where system-specified (1002) is designated, the printer 101 performs processing in accordance with the release method set in the printer 101.

On the other hand, in a case where forced-print (1003) is designated, regardless of the release method set in the printer, the printer 101 does not store the print job after receiving it and executes printing without receiving a print instruction from the user.

The secure print setting in the printer in the present embodiment will be described with reference to FIG. 11.

The screen of FIG. 11 is displayed on the display panel 605 of the printer 101. A print setting screen 1101 is a top screen for performing print setting of the printer 101. The setting of secure print is displayed in 1102. The storage time of the job stored in the printer 101 is displayed in 1103.

When 1102 is selected, the screen transitions to a screen 1111 for changing the secure print setting. In 1111, the secure print setting can be switched between ON and OFF.

When the secure print setting is set to ON, the printer 101 stores all the received print jobs into the storage. Printing is not performed at the timing of reception, and printing is not performed unless a print instruction for a print job is received again from the user. Such a printing method is called hold printing.

When 1103 is selected, the screen transitions to a screen (not illustrated) for setting the storage time of the job. On this screen, the storage time can be set. As hold printing, the print job stored in the printer 101 is automatically erased after the storage time elapses. By setting the storage time, the print job is automatically erased when the user does not give a print instruction, and therefore, it is possible to prevent the print job from remaining in the storage due to the user forgetting to give the print instruction.

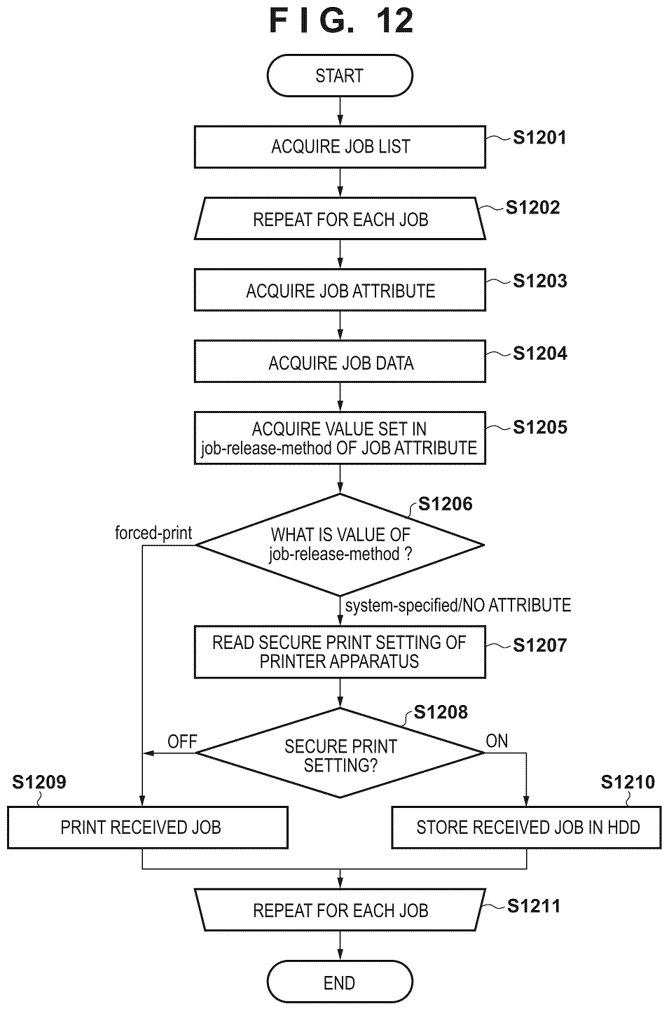

With reference to FIG. 12, the processing when the printer 101 in the present embodiment receives a cloud print job reception event will be described. The processing described below is realized, for example, by the CPU 402 of the printer 101 reading, and executing, a program stored in the ROM 404 or the HDD 414 into the RAM 403. Hereinafter, the step number of each process included in the flowchart is indicated by a number starting with “S”. The same applies to the subsequent flowcharts.

In S1201, the cloud print printing control unit 502 of the printer 101 acquires a job list by inquiring the cloud print service 102. Upon acquiring the job list, the cloud print printing control unit 502 repeats the processing from S1202 to S1211 for the jobs included in the acquired job list.

In S1203, the cloud print printing control unit 502 of the printer 101 acquires the job attribute of the designated job by inquiring the cloud print service 102, and the process proceeds to S1204.

In S1204, the cloud print printing control unit 502 of the printer 101 acquires the job data of the designated job by inquiring the cloud print service 102, and the process proceeds to S1205.

In S1205, the cloud print job information management unit 503 of the printer 101 acquires the value of job-release-method from the job attribute acquired in S1203, and the process proceeds to S1206.

In S1206, the cloud print printing control unit 502 of the printer 101 branches the processing in accordance with the value of job-release-method. When the value of job-release-method is forced-print, the process proceeds to S1209, and in S1209, the cloud print printing control unit 502 of the printer 101 prints the received job data in accordance with the received job attribute. When the value of job-release-method is system-specified or the attribute itself does not exist, the process proceeds to S1207. In S1207, the storage unit 506 of the printer 101 reads the secure print setting stored in the HDD 414, and the process proceeds to S1208.

In S1208, the cloud print printing control unit 502 of the printer 101 branches the processing in accordance with the value of the secure print setting. When the value of the secure print setting is OFF, the process proceeds to S1209, and in S1209, the cloud print printing control unit 502 of the printer 101 prints the received job data in accordance with the received job attribute. When the value of the secure print setting is ON, the process proceeds to S1210, and in S1210, the storage unit 506 of the printer 101 stores the received job data into the HDD 414.

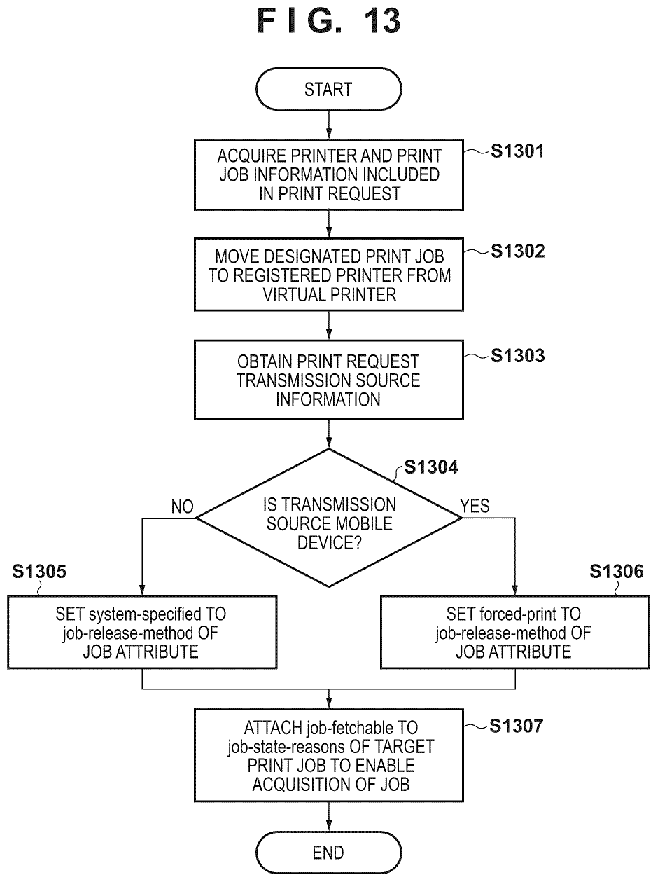

With reference to FIG. 13, the processing when the cloud print service 102 in the present embodiment receives a job print request will be described. The processing described below is realized, for example, by the CPU 702 of the cloud server of the cloud print service 102 reading, and executing, a program stored in the ROM 704 or the HDD 705 into the RAM 703.

In S1301, the cloud print printing control unit 802 of the cloud print service 102 acquires information (job ID) of the printer and the print job included in the print request, and the process proceeds to S1302.

In S1302, the cloud print printing control unit 802 of the cloud print service 102 moves the designated print job from the virtual printer to the registered printer, and the process proceeds to S1303.

In S1303, the cloud print printing control unit 802 of the cloud print service 102 acquires transmission source information of the print request, and the process proceeds to S1304.

In S1304, the cloud print printing control unit 802 of the cloud print service 102 branches the processing in accordance with the transmission source of the print request.

When the transmission source is a mobile device, the process proceeds to S1306. In S1306, the cloud print job information management unit 806 of the cloud print service 102 adds job-release-method to the job attribute of the target print job and sets forced-print to the value, and the process proceeds to S1307.

When the transmission source is not a mobile device, the process proceeds to S1305. In S1305, the cloud print job information management unit 806 of the cloud print service 102 adds job-release-method to the job attribute of the target print job and sets system-specified to the value, and the process proceeds to S1307.

In S1307, the cloud print job information management unit 806 sets job-fetchable to job attribute job-state-reasons of the target print job, and enables the printer 101 to acquire the print job.

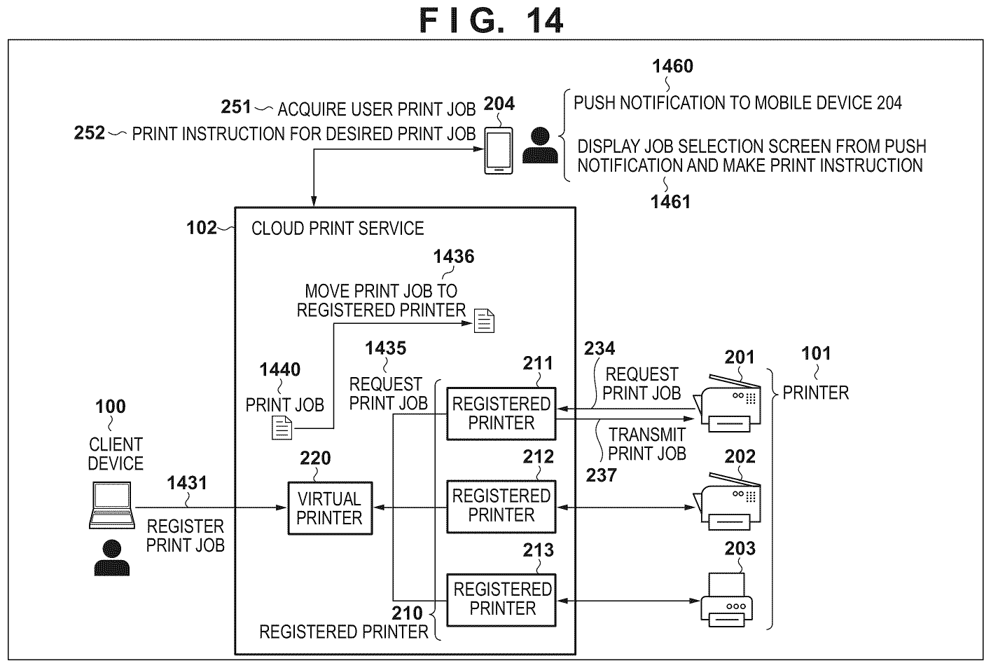

With reference to FIG. 14, the processing will be described in which print execution is instructed by submitting a print job to the cloud print service 102 of the present embodiment in the form of pull printing, and transmitting push notification to the mobile device 204.

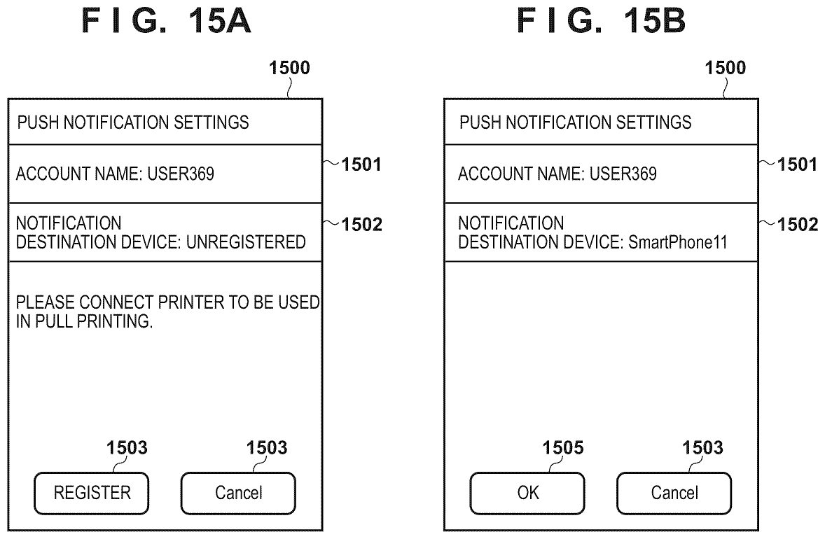

In order to perform push notification to the mobile device 204, it is necessary to register the push notification in advance. An application program on the mobile device 204 is activated to display a push notification setting screen 1500 illustrated in FIG. 15A. For an account name 1501, the account name with which the cloud print service 102 is already logged in is displayed. Since a notification destination device 1502 for push notification is not registered in the initial setting, “unregistered” is displayed. Here, when a registration button 1503 is selected, registration of the push notification destination device is performed. When a cancel button 1504 is selected, the screen is closed without performing the registration processing.

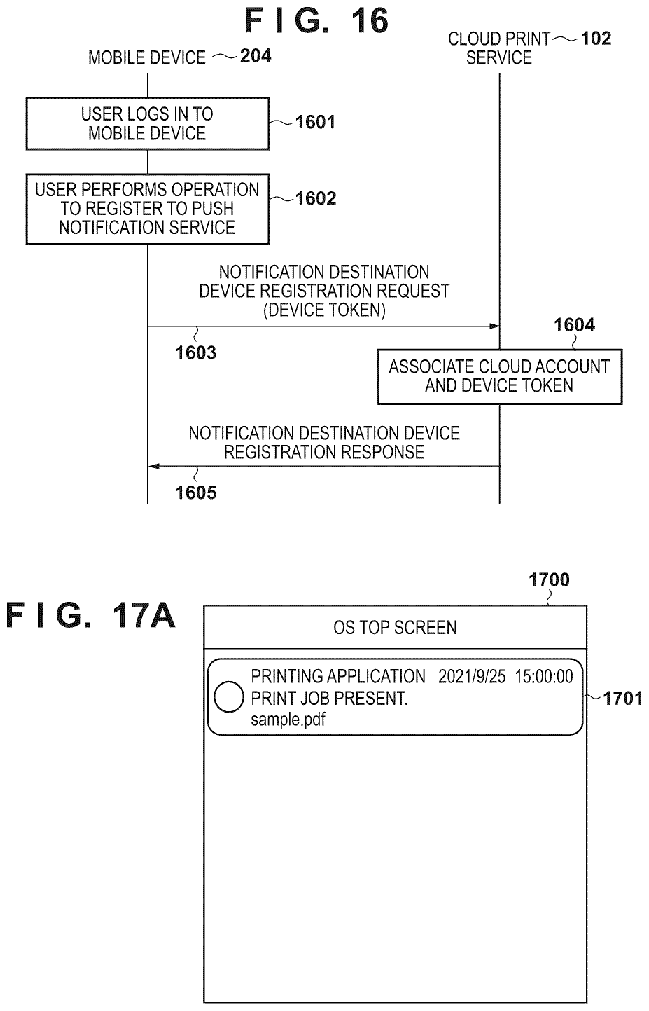

FIG. 16 illustrates the processing sequence when the registration button 1503 is selected. The user activates the application program on the mobile device 204, logs in to the cloud print service 102 (1601), and then performs a registration operation on the push notification service control unit 809 (1602). The mobile device 204 makes (1603) a notification destination device registration request to the cloud print service 102. Notification destination device information is identification information of the mobile device 204, and includes, for example, a device token necessary for push notification reception and OS information (OS type, OS version, and the like) installed on the mobile device 204. The device token is information provided from the OS when the installed OS of the mobile device 204 is iOS, and includes identification information of the application program on the mobile device 204. When the OS of the mobile device 204 is Android, it is called a registration token, but an example of device token will be described here. Upon receiving the notification destination device information, the cloud print service 102 stores (1604), in the storage unit 805, the cloud account and the device token in association with each other.

Due to this, when the client device 100 registers (1431) the print job in FIG. 14, it is identified as to which mobile device 204 pull printing execution information is to be transmitted. In this manner, the registration processing is completed. When the setting screen is displayed again after the registration is completed, the push notification setting screen 1500 illustrated in FIG. 15B is displayed, and the setting information of the notification destination device 1502 for push notification can be confirmed.

Note that the transmission method of registration information in the registration processing is not particularly limited. For example, the transmission method may be the HTTP method in which registration information is converted into an HTML format and transmitted, or may be the FTP method in which registration information is created as a file format and the file is transmitted. The registration information may be data encrypted by a security key shared between the push notification service control unit 809 of the cloud print service 102 and the application program on the mobile device 204. The registration information may be binary data, text data such as UTF-8, or data encoded by a method such as Base64.

In FIG. 14, when the user registers (1431) the print job to the virtual printer 220 from the client device 100, the cloud print service 102 transmits (1460), by push notification, a message indicating that the print job has been submit to the mobile device 204. Upon receiving notification information, a mobile device 1404 displays, on the display by a push notification function, a notification area (push notification area) for notifying a message corresponding to the notification information.

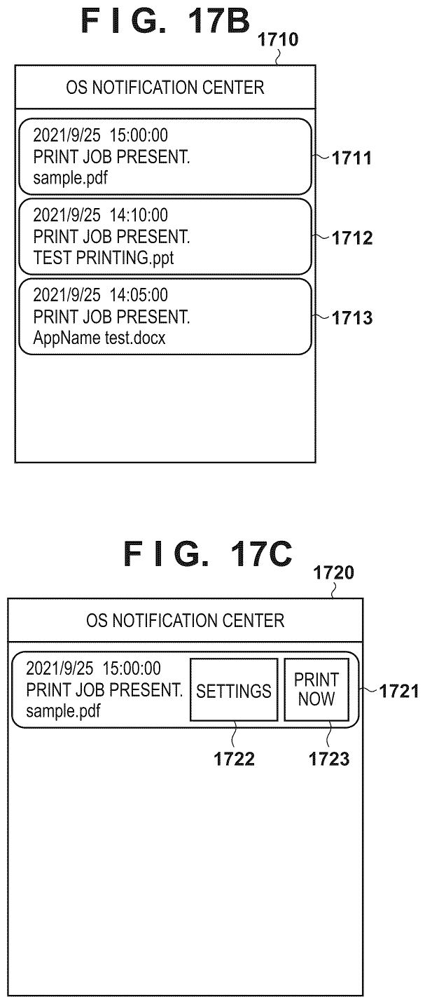

FIG. 17A is an example of a screen in a state where a message is displayed in the notification area by the push notification function. A top screen 1700 of the OS indicates a maximum area that can be displayed by the display, and a notification area 1701 indicates an area for notifying a message corresponding to the notification information. Note that in the present embodiment, the push notification function of displaying the notification area 1701 on the display by push notification is realized by the OS installed on the mobile device 204.

The push notification function is a function that can send a notification to an application program on the mobile device 204 even in a state where the application program is not activated. That is, by the push notification function, the notification area 1701 can be displayed also in a state where the application program of the mobile device 204 is operating in the background, a state where the application program is not activated, or a state where a home screen is displayed.

Note that the message corresponding to the notification information may include print job information, account information, and a uniform resource locator (URL) in addition to the character string of the display message. The notification area 1701 includes a name or an icon of the application program, a notification time, and a display message, which are items related to the notification information. The notification time indicates information regarding the date and time when the notification information is received. This enables the user to easily grasp when and what push notification has been made.

In FIG. 14, the user selects the push notification information notified to the mobile device 204 to display his/her own print job list, designates a desired job, and instructs print execution (1461). The printer 201 requests (1434) the corresponding registered printer 211 for the print job designated in 1461. The registered printer 211 requests (1435) the virtual printer 220 for the print job. The virtual printer 220 moves (1436) the print job to the registered printer 211. The registered printer 211 transmits (1437) the print job to the printer 201 as a response to a print job request 1434. The printer 201 prints the received print job.

In this manner, by a simple operation of tapping the push notification information notified to the mobile device, the user can display a job selection screen of pull printing, and can designate a desired job and give an instruction for print execution.

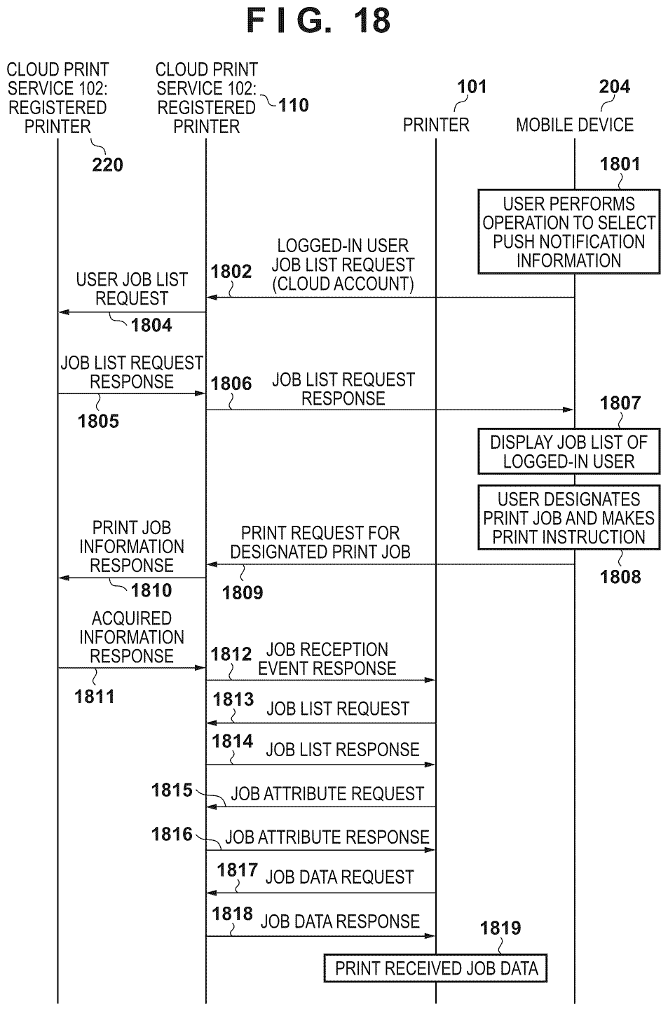

The processing in which the mobile device 204 receives the push notification and executes the print job of pull printing will be described with reference to FIG. 18. When the notification area 1701 of FIG. 17A is selected by an operation by the user, the OS analyzes the notification information and activates the application program registered in the push notification service control unit 809. Since the notification information includes information on the application program corresponding to the notification information, it is possible to specify as to which application program the notification information corresponds to. The notification information includes print job information and account information, and the activated application program can acquire the information.

The mobile device 204 requests (1802) the registered printer 110 on the cloud print service 102 for a job list of the logged-in user associated with the account information included in the notification information. The registered printer 110 on the cloud print service 102 requests (1804) the virtual printer 220 for a job list of the logged-in user associated with the account information of 1802. The virtual printer 220 on the cloud print service 102 responds (1805) to the registered printer 110 for a job list of the logged-in user associated with the account information designated in 1804. The registered printer 110 on the cloud print service 102 responds (1806) to the mobile device 204 for a job list of the logged-in user associated with the account information designated in 1802.

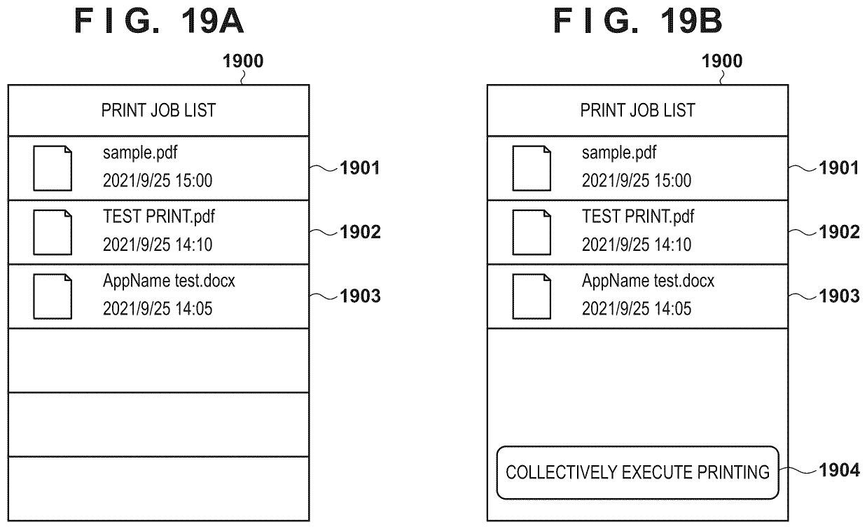

The mobile device 204 displays (1807) a print job list screen 1900 as illustrated in FIG. 19A. 1901, 1902, and 1903 each denote a print job submitted to and managed by the cloud print service 102. For each item, an icon, a job name of the print job, and date and time information when the print job is submitted are arranged. The icon may be an icon that can identify the file type of the print job target.

The user selects a desired job from the displayed print job list screen and performs an operation for performing printing (1808). When selecting the job, the user may display a setting screen for performing print setting and may perform print settings such as the number of copies, paper size, color printing, and duplex printing. The mobile device 204 transmits (1809) a print request for the designated print job to the registered printer 110 on the cloud print service 102. The registered printer 110 on the cloud print service 102 requests (1810) the virtual printer 220 for information on the print job designated in 1809. The virtual printer 220 on the cloud print service 102 responds (1811) to the registered printer 110 for the print job information designated in 1810.

The registered printer 110 on the cloud print service 102 responds (1812) to the printer 101 for a job reception event. The printer 101 transmits (1813) a job list request to the registered printer 110 on the cloud print service 102. The registered printer 110 on the cloud print service 102 transmits (1814) a job list response to the printer 101. The printer 101 transmits (1815) a job attribute request to the registered printer 110 on the cloud print service 102. The registered printer 110 on the cloud print service 102 transmits (1816) a job attribute response to the printer 101. The printer 101 transmits (1817) a job data request to the registered printer 110 on the cloud print service 102. The registered printer 110 on the cloud print service 102 transmits (1818) a job data response to the printer 101. The printer 101 outputs (1819) the received job data in accordance with the received job attribute. Note that the processing of 1810 to 1819 in FIG. 18 is the same as the processing of 910 to 919, respectively, in FIG. 9.

Such a form enables the user to execute a job of pull printing by a simple operation of tapping the push notification displayed on the smartphone. That is, the user no longer need to search for and activate an application program that executes pull printing of the smartphone, select a function for executing pull printing after activation, or perform an operation of logging in to the cloud print service.

FIG. 17B is an example of a screen in a state where messages related to a plurality of print jobs are displayed in the notification area by the push notification function. A notification center screen 1710 of the OS indicates a maximum area displayable by the display, and notification areas 1711 to 1713 indicate areas for providing notification of messages corresponding to the notification information. The notification areas 1711 to 1713 include a name or an icon of the application program, a notification time, and a display message, which are respective items related to the notification information. The notification time indicates information regarding the date and time when the notification information is received, and the received latest notification message is displayed in descending order from the top of the notification center screen 1710 of the OS. Note that the display of the notification center screen 1710 is controlled by the OS, and a plurality of notification messages may be displayed in a list in ascending order, or similar notification messages may be collectively displayed. Even when the screen of the mobile device 204 is in a state of being locked, a push notification message may be displayed in the notification area, and unlock may be requested when the user performs a selection operation.

The print jobs of the plurality of notification messages of push notification correspond to the respect jobs on the print job list screen 1900 as illustrated in FIG. 19B. Therefore, a desire to print all the jobs by one operation can be realized by the cloud print service 102 repeatedly instructing the printer 101 for print execution to each job by operating a print execution button 1904 collectively. Of course, the print job list screen illustrated in FIG. 19B may be provided with a check box for selecting each job so that the user can select a plurality of discretionary jobs.

### Second Embodiment

In the first embodiment, the print job list screen 1900 illustrated in FIG. 19A is displayed on the mobile device 204, and the user selects a desired job from the displayed print job list screen and performs the operation for performing printing. In the second embodiment, printing is executed without displaying the print job list screen.

The notification information 1701 of FIG. 17A includes a job ID submitted by the user. When the user operates the push notification information 1701 on the mobile device 204, the OS analyzes the notification information and activates the application program registered in the push notification service control unit 809. Since the notification information includes information on the application program corresponding to the notification information, it is possible to specify as to which application program the notification information corresponds to. The notification information includes print job information including a print job ID and account information, and the activated application program can acquire the information.

The mobile device 204 transmits the account information and the print job ID included in the notification information to the registered printer 110 on the cloud print service 102. At this time, the user may display a setting screen for performing print setting and may perform print settings such as the number of copies, paper size, color printing, and duplex printing. The cloud print service 102 transmits job data to the printer 101 based on the account information and the print job ID. The printer 101 prints the received job data in accordance with the job attribute. Since the notification information 1711, 1712, and 1713 in FIG. 17B also include a print job ID, a desired job can be printed by operating those notification information.

Furthermore, some OSs installed in the mobile device 204 have a custom action function for a notification center. For example, FIG. 17C illustrates a notification center screen 1720 of the OS. A notification area 1721 of push notification includes actions of a setting button 1722 and an immediate print button 1723. The user may display a print job selection screen by operating the setting button 1722, and may instruct starting of printing without displaying the print job selection screen by operating the immediate print button 1723.

In the present embodiment, the processing of 1802 to 1809 of FIG. 18 can be omitted, and the user does not need to designate a print job from job list display. Since the user can execute print of pull printing by a simple operation of tapping the push notification displayed on the smartphone, the operability of the user is good.

### Third Embodiment

In 1461 in FIG. 14, by selecting the push notification information notified to the mobile device 204, the user displays his/her own print job list. At this time, in a case where there are a plurality of registered printers, the user designates a desired printer and a desired job and instructs print execution. In a case where there is one registered printer, it is not necessary to designate the printer.

An application program of the mobile device 204 may detect that the user is in the vicinity of the printer used for printing, and the printer used for printing may be automatically decided. For example, when an application program of the mobile device 204 displays a print job selection screen, the mobile device 204 communicates with the printer 101 by near field communication such as Bluetooth. If the detected printer is a registered printer, the printer is decided as a printer used for printing, and the user can skip the operation of selecting a printer.

Specifically, it is assumed that the mobile device 204 and the printer 101 each include a Bluetooth control module, and can perform communication by Bluetooth. When the mobile device 204 having received push notification related to a print job approaches the printer 101, the CPU of the mobile device 204 receives an advertising packet for performing Bluetooth communication from the printer 101. The advertising packet received by the Bluetooth control module of the mobile device 204 includes device information indicating the name and function of the printer 101 of the transmission source and a radio field intensity value indicating output intensity.

The CPU of the mobile device 204 acquires the radio field intensity value included in the advertising packet received from the printer 101. Next, the CPU of the mobile device 204 determines whether the acquired radio field intensity value is equal to or greater than a predetermined threshold set in advance. A radio field intensity value of, for example, about −70 dBm is set as the predetermined threshold of the radio field intensity.

As a result of the determination, when the acquired radio field intensity value is equal to or greater than the predetermined threshold, it is judged that the mobile device 204 is in the vicinity of the printer 101, and if the detected printer is a registered printer, the printer is decided as a printer used for printing. This enables the user to skip the operation of selecting the printer.

On the other hand, when the acquired radio field intensity value is less than the predetermined threshold, it is judged that the mobile device 204 is not in the vicinity of the printer 101, and the user selects a printer that executes printing from the registered printers.

Note that the predetermined threshold of the radio wave intensity can be discretionally set, and it may be judged that the mobile device 109 and the printer 101 are in the vicinity at the time point of receiving the advertising packet. An instruction for execution of a print job from the mobile device 204 may be disabled in a case where the mobile device 204 is not in the vicinity of the registered printer 101. This can enhance the security of pull printing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-195298, filed Nov. 16, 2023 which is hereby incorporated by reference herein in its entirety.

What is claimed is:

1. A cloud print system including a printer, a cloud server, and a mobile device, executes printing of, by the printer based on an instruction from the mobile device, a print job submitted to and stored in the cloud server, wherein
the cloud server comprises:
one or more first memory devices that store a set of instructions; and
one or more first processors that execute the set of instructions to:
receive a print job submitted by a user;
store the print job in the one or more first memory device;
transmit, by push notification, information regarding the print job to a mobile device of a notification destination associated with a user who submits the received print job; and
transmit the print job stored in the one or more first memory device to the printer based on an instruction for execution of the print job, and
the mobile device comprises:
a display;
one or more second memory devices that store a set of instructions; and
one or more second processors that execute the set of instructions to:
receive the push notification from the cloud server;
display a message on the display when receiving the push notification; and
transmit an instruction for execution of the print job to the cloud server based on a user's operation on the message.

2. The cloud print system according to claim 1, wherein
display of the message on the display is displayed by a notification function provided by an OS of the mobile device.

3. The cloud print system according to claim 1, wherein
the one or more second processors execute instructions in the one or more second memory devices to:
cause an application program of the mobile device to display an operation screen for operating the print job in response to a user's operation on the message in the mobile device.

4. The cloud print system according to claim 1, wherein
the push notification includes information specifying an application program of the mobile device, and
the one or more second processors execute instructions in the one or more second memory devices to:
activate the application program of the mobile device in accordance with a user's operation on the message, and cause the mobile device to display an operation screen for operating the print job on the application program.

5. The cloud print system according to claim 1 wherein
the one or more second processors execute instructions in the one or more second memory devices to:
request the cloud server from acquisition of a print job list in response to a user's operation on the message,
the one or more first processors execute instructions in the one or more second memory devices to:
receive the request and transmit a print job list corresponding to the user to the mobile device, and
the one or more second processors execute instructions in the one or more second memory devices to:
receive the print job list and display the print job list on a display; and
instruct execution of a selected print job upon receiving selection by a user of a part or an entirety of the print job list.

6. The cloud print system according to claim 1 wherein
the message to the display includes information specifying a print job, and
the one or more second processors execute instructions in the one or more second memory devices to:
transmit, to the cloud server, an instruction for the display to display a setting button and a print button, to display a setting screen for printing of the print job when the setting button is operated by a user, and to execute the print job without displaying the setting screen when the print button is operated by a user.

7. The cloud print system according to claim 1 wherein
job attribute information instructing a job release method of system specific or forced printing is set in the print job, and
the printer comprises:
executing printing of the print job by a release method set in the printer when the job attribute information is system specific; and
executing printing of the print job regardless of setting of the printer when the job attribute information is forced printing.

8. The cloud print system according to claim 7 wherein
the one or more first processors execute instructions in the one or more first memory devices to:
set, in the print job, job attribute information instructing a job release method of forced printing, upon receiving, from the mobile device, an instruction for execution of the print job.

9. The cloud print system according to claim 1 wherein
the one or more first processors execute instructions in the one or more first memory devices to:
register a printer into the one or more first memory in association with a user, and
when the printer in a vicinity of the mobile device is a printer registered in a registration unit,
a second transmission unit transmits the print job to the registered printer.

10. The cloud print system according to claim 1 wherein
receiving the print job submitted by the user is receiving the print job using an Internet Printing Protocol.

11. A method for controlling a cloud print system including a printer, a cloud server, and a mobile device, wherein the cloud print system executes printing of, by the printer based on an instruction from the mobile device, a print job submitted to and stored in the cloud server, the method wherein
the cloud server
receives a print job submitted by a user,
stores the print job, and
transmits, by push notification, information regarding the print job to a mobile device of a notification destination associated with a user who submits the received print job,
the mobile device
receives the push notification from the cloud server,
displays a message on a display upon receiving the push notification, and
transmits an instruction for execution of the print job to the cloud server based on a user's operation on the message, and
the cloud server
transmits the print job stored in a storage unit to the printer based on an instruction for execution of the print job.
